(19) United States
(12) Patent Application Publication
(10) Pub. No.: US 2009/0278898 A1
(43) Pub. Date: Nov. 12, 2009

(54) METHOD OF MANUFACTURING INKJET PRINTHEAD AND INKJET PRINTHEAD MANUFACTURED USING THE SAME

(75) Inventors: Byung-ha PARK, Suwon-si (KR); Young-ung HA, Suwon-si (KR); Yong-won JEONG, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/414,747

(22) Filed: Mar. 31, 2009

(30) Foreign Application Priority Data
May 8, 2008 (KR) 2008-42865

(51) Int. Cl. B41J 2/05; B21D 53/76

(52) U.S. Cl. 347/63; 29/890.1

(57) ABSTRACT

A method of manufacturing an inkjet printhead includes forming a heater and an electrode on a substrate, forming a flow path forming layer by coating a first negative photoresist composition on the substrate, forming a sacrifice layer, planarizing the flow path forming layer and the sacrifice layer, forming a nozzle layer by coating a second negative photoresist composition on the flow path forming layer, forming an ink feed hole in the substrate, and eliminating the sacrifice layer, wherein the first and second negative photoresist compositions include a prepolymer which comprises one selected from the group consisting of a glycidyl ether functional group, a ring-opened glycidyl ether functional group, and an oxytein functional group in a monomer repeat unit, and one selected from the group consisting of a phenol novolac resin-based backbone, a bisphenol-A-based backbone, a bisphenol-F-based backbone, and an alicyclic backbone; a cationic initiator; a solvent; and a plasticizer.

### CROSS-REFERENCE TO RELATED APPLICATIONS

This application claims the benefit of Korean Patent Application No. 10-2008-0042865, filed on May 8, 2008, in the Korean Intellectual Property Office, the disclosure of which is incorporated herein in its entirety by reference.

### BACKGROUND OF THE INVENTION

1. Field of the Invention

The present general inventive concept relates to a method of manufacturing an inkjet printhead and an inkjet printhead manufactured using the method, and more particularly, to a method of manufacturing an inkjet printhead having a reduced amount of nozzle cracks and smaller nozzle chamber angles by increasing a flexibility of a nozzle plate and an inkjet printhead manufactured using the method.

2. Description of the Related Art

Inkjet printheads are devices for printing an image on a printing medium by ejecting droplets of ink from inkjet printheads onto a desired region of the printing medium. Inkjet printheads can be classified into two types depending on the mechanism of ejecting ink droplets; thermal inkjet printheads and piezolelectric inkjet printheads. Thermal inkjet printheads generate bubbles in the ink to be ejected by using heat and eject ink droplets by utilizing an expansion of the bubbles, and piezoelectric inkjet printheads eject ink droplets by using pressure generated by deforming a piezoelectric material. However, thermal inkjet printheads and piezoelectric inkjet printheads are the same since both printheads eject ink droplets by using a uniform energy, even though both printheads have different operating devices.

FIG. 1 illustrates a cross-sectional view of a typical structure of a thermal inkjet printhead.

Referring to FIG. 1, the thermal inkjet printhead 1 includes a substrate 10, a flow path forming layer 20 formed on the substrate 10, and a nozzle layer 30 formed on the flow path forming layer 20. The substrate 10 has an ink feed hole 51, and the flow path forming layer 20 includes an ink chamber 53 in which ink is filled and a restrictor 52 which connects the ink feed hole 51 with the ink chamber 53. The nozzle layer 30 includes nozzles 54 through which ink from the ink chamber 53 is ejected from. A heater 41, which heats ink in the ink chamber 53, and an electrode 42, which supplies current to the heater 41, are formed on the substrate 10.

A mechanism of ejecting ink droplets in the thermal inkjet print head 1 having the above-described structure will now be described. Ink is supplied from a storage (not illustrated) to the ink chamber 53 through the ink feed hole 51 and the restrictor 52. The ink stored in the ink chamber 53 is heated by the heater 41 which is formed of a resistance heating material that is disposed in the ink chamber 53. Thus, the ink boils and thereby generates bubbles which expand to apply pressure to the ink in the ink chamber 53. As a result, the ink is ejected from the ink chamber 53 through the nozzles 54 in the form of droplets.

A method of manufacturing an inkjet printhead is disclosed in U.S. Patent Application Publication No. 2007/0017894. The method includes a flow path wall forming step of forming flow path walls on a substrate having energy generating elements formed thereon, an imbedded material depositing step of depositing an imbedded material between the flow path walls and on top of each flow path wall, a flattening step of polishing the top of the deposited imbedded material until the top of each flow path wall is exposed, and a step of forming an orifice plate on the tops of the polished imbedded material and the exposed flow path walls.

However, multi-functional epoxy resins, which are used to form nozzles in the method of manufacturing an inkjet printhead, may cause cracks in a nozzle layer after the nozzles are developed and a sacrifice layer is removed. Furthermore, since a nozzle chamber angle (NCA) of the inkjet printhead structure formed of the multi-functional epoxy resins is greater than 1 degree, a quality of images formed by the inkjet printhead may be reduced.

Thus, there is a need to develop an inkjet printhead which employs a novel material that may prevent or substantially reduce nozzle cracks and image quality deterioration, and a method of manufacturing such an inkjet printhead.

### SUMMARY OF THE INVENTION

The present general inventive concept provides a method of manufacturing an inkjet printhead which may prevent or substantially reduce nozzle cracks and image quality deterioration.

The present general inventive concept also provides an inkjet printhead manufactured using the above method.

According to an exemplary embodiment of the present general inventive concept, there is provided a method of manufacturing an inkjet printhead, the method includes forming a heater to heat ink and an electrode to supply current to the heater on a substrate, forming a flow path forming layer, which defines a flow path of the ink on the substrate, on which the heater and the electrode are disposed, by coating a first negative photoresist composition on the substrate and patterning the first negative photoresist composition using a photolithography process, forming a sacrifice layer on the substrate, on which the flow path forming layer is disposed, so as to cover the flow path forming layer, planarizing a top surface of the flow path forming layer and the sacrifice layer using a polishing process, forming a nozzle layer having nozzles by coating a second negative photoresist composition on the flow path forming layer and the sacrifice layer and patterning the second negative photoresist composition by using a photolithography process, forming an ink feed hole in the substrate, and eliminating the sacrifice layer, wherein the first and second negative photoresist compositions comprise a prepolymer which comprises one selected from the group consisting of a glycidyl ether functional group, a ring-opened glycidyl ether functional group, and an oxytein functional group in a monomer repeat unit, and one selected from the group consisting of a phenol novolac resin-based backbone, a bisphenol-A-based backbone, a bisphenol-F-based backbone, and an alicyclic backbone; a cationic initiator; a solvent; and a plasticizer.

The polishing process may include chemical mechanical planarization.

The first and second negative photoresist compositions may be substantially similar.

The forming of the flow path forming layer may include forming a first photoresist layer by coating the first negative photoresist composition on a surface of the substrate, exposing the first photoresist layer to a light by using a first photomask having an ink flow path pattern, and eliminating portions which are not exposed to the light by developing the first photoresist layer.

The sacrifice layer may include a positive photoresist polymer or a non-sensitized soluble polymer.

The positive photoresist polymer may be an imide-based positive photoresist polymer.

The non-sensitized soluble polymer may be at least one selected from the group consisting of a phenol resin, a polyurethane resin, an epoxy resin, a poly imide resin, an acryl resin, a poly amide resin, an urea resin, a melamine resin, and a silicon resin.

The forming of the sacrifice layer may be performed by using a spin coating process.

The forming of the nozzle layer may include forming a second photoresist layer by coating a second negative photoresist composition on the flow path forming layer and the sacrifice layer, exposing the second photoresist layer to a light by using a second photomask having a nozzle pattern, and forming nozzles and a nozzle layer by eliminating portions which are not exposed to the light by developing the second photoresist layer.

The forming of the ink feed hole may include coating a photoresist composition on a bottom surface of the substrate, forming an etching mask in order to form the ink feed hole by patterning the photoresist composition, and forming the ink feed hole by etching the bottom surface of the substrate which is exposed through the etching mask.

The bottom surface of the substrate may be etched using a dry etching method using plasma.

The bottom surface of the substrate may be etched using a wet etching method using tetra-methyl ammonium hydroxide (TMAH) or KOH as an etching solution.

The first and second negative photoresist compositions may respectively include about 1 to about 10 parts by weight of the cationic initiator, about 30 to about 300 parts by weight of the solvent, and about 1 to about 15 parts by weight of the plasticizer, based on 100 parts by weight of the prepolymer.

The prepolymer may include a backbone monomer selected from the group consisting of phenol, o-cresol, p-cresol, bisphenol-A, an alicyclic compound, and a mixture thereof.

The prepolymer may include at least one compound selected from the group consisting of the compounds represented by Formulae 1 to 9 below:

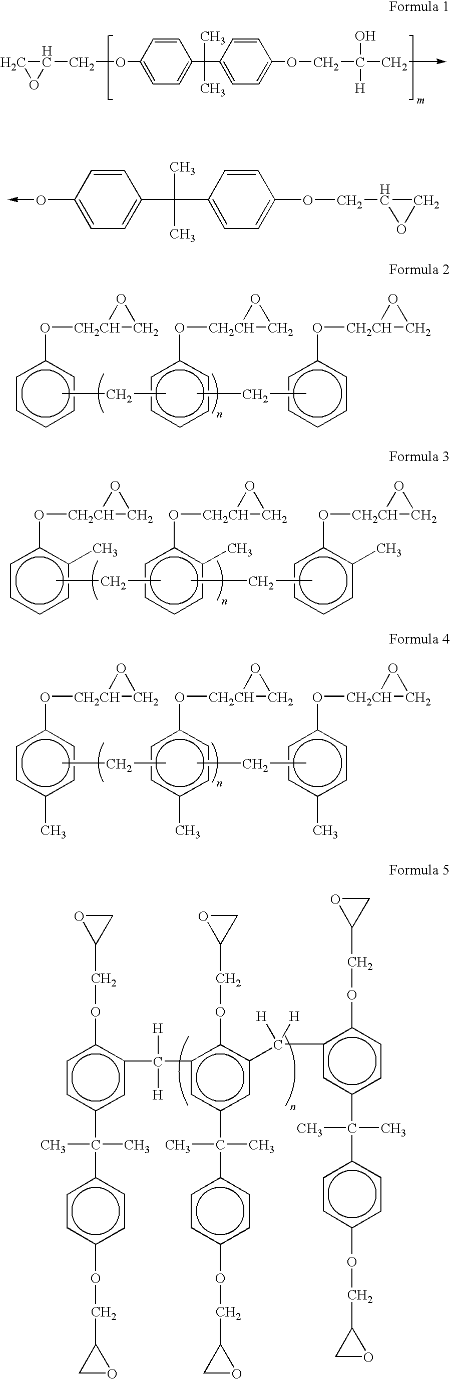

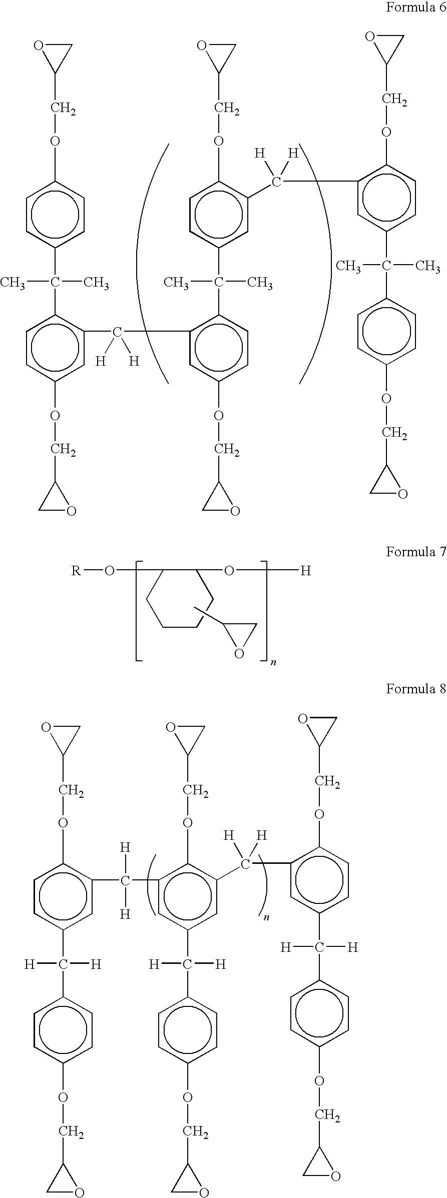

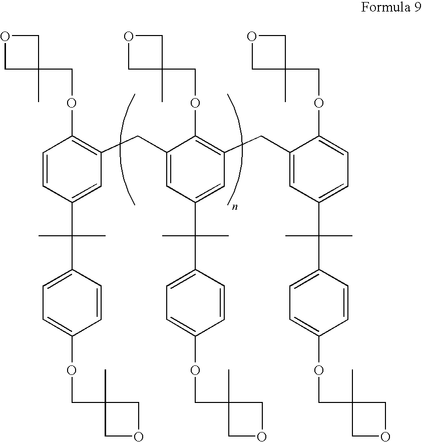

where m is may be an integer from 1 to 20, and n may be an integer from 1 to 20.

The cationic initiator may be a sulfonium salt or an iodonium salt.

The solvent may be at least one selected from the group consisting of γ-butyrolactone, propylene glycol methyl ethyl acetate (PGMEA), tetrahydrofuran (THF), methyl ethyl ketone, methyl isobutyl ketone, cyclopentanone, and a mixture thereof.

The plasticizer may be at least one selected from the group consisting of a phthalate-based compound, a trimellitate-based compound, and a phosphite-based compound.

The plasticizer may be at least one selected from the group consisting of dioctyl phthalate, diglycidyl hexahydro phthalate, triethylhexyl trimellitate, and tricresyl phosphite.

According to another exemplary embodiment of the present general inventive concept, there is provided a method of manufacturing an inkjet printhead, the method includes forming a flow path layer on a substrate by disposing a first negative photoresist composition on the substrate and forming a nozzle layer by disposing a second negative photoresist composition on the flow path layer, wherein the first and second negative photoresist compositions comprise a prepolymer, a cationic initiator, a solvent, and a plasticizer.

According to another exemplary embodiment of the present general inventive concept, there is provided an inkjet printhead manufactured by forming a heater to heat ink and an electrode to supply current to the heater disposed on a substrate, forming a flow path forming layer which defines a flow path of ink on the substrate, on which the heater and the electrode are disposed, by coating a first negative photoresist composition on the substrate and patterning the first negative photoresist composition using a photolithography process, forming a sacrifice layer on the substrate, on which the flow path forming layer is disposed, so as to cover the flow path forming layer, planarizing a top surface of the flow path forming layer and the sacrifice layer using a polishing process, forming a nozzle layer having nozzles by coating a second negative photoresist composition on the flow path forming layer and the sacrifice layer and patterning the second negative photoresist composition using a photolithography process, forming an ink feed hole in the substrate, and eliminating the sacrifice layer, wherein the first and second negative photoresist compositions comprise a prepolymer which comprises one selected from the group consisting of a glycidyl ether functional group, a ring-opened glycidyl ether functional group, and an oxytein functional group in a monomer repeat unit, and one selected from the group consisting of a phenol novolac resin-based backbone, a bisphenol-A-based backbone, a bisphenol-F-based backbone, and an alicyclic backbone; a cationic initiator; a solvent; and-a plasticizer.

According to yet another exemplary embodiment of the present general inventive concept, there is provided an image forming apparatus which includes an inkjet printhead manufactured by forming a heater to heat ink and an electrode to supply current to the heater disposed on a substrate, forming a flow path forming layer which defines a flow path of ink on the substrate, on which the heater and the electrode are disposed, by coating a first negative photoresist composition on the substrate and patterning the first negative photoresist composition using a photolithography process, forming a sacrifice layer on the substrate, on which the flow path forming layer is disposed, so as to cover the flow path forming layer, planarizing a top surface of the flow path forming layer and the sacrifice layer using a polishing process, forming a nozzle layer having nozzles by coating a second negative photoresist composition on the flow path forming layer and the sacrifice layer and patterning the second negative photoresist composition using a photolithography process, forming an ink feed hole in the substrate, and eliminating the sacrifice layer, wherein the first and second negative photoresist compositions comprise a prepolymer which comprises one selected from the group consisting of a glycidyl ether functional group, a ring-opened glycidyl ether functional group, and an oxytein functional group in a monomer repeat unit, and one selected from the group consisting of a phenol novolac resin-based backbone, a bisphenol-A-based backbone, a bisphenol-F-based backbone, and an alicyclic backbone; a cationic initiator; a solvent; and a plasticizer, and an image forming unit to form an image by using the inkjet printhead.

### BRIEF DESCRIPTION OF THE DRAWINGS

The above and/or other features and utilities of the present general inventive concept will become more apparent by describing in detail exemplary embodiments thereof with reference to the attached drawings, in which:

FIG. 1 illustrates a cross-sectional view of a typical structure of a thermal inkjet printhead;

FIGS. 2A to 2L illustrate cross-sectional views for describing a method of manufacturing an inkjet printhead, according to an exemplary embodiment of the present general inventive concept;

FIG. 3 is an optical microscope image of a nozzle layer prepared according to Comparative Example 1 after nozzles are developed in the nozzle layer;

FIG. 4 is an optical microscope image of a nozzle layer prepared according to Example 1 after nozzles are developed in the nozzle layer;

FIG. 5 is an optical microscope image of a nozzle layer prepared according to Comparative Example 1 after a sacrifice layer is eliminated;

FIG. 6 is an optical microscope image of a nozzle layer prepared according to Example 1 after a sacrifice layer is eliminated;

FIG. 7 illustrates a graph of nozzle chamber angles of nozzles of an inkjet printhead formed according to Comparative Example 1;

FIG. 8 illustrates a graph of nozzle chamber angles of nozzles of an inkjet printhead formed according to Example 1;

FIG. 9 illustrates a graph of Y spacing of the nozzles of the inkjet printhead prepared according to Comparative Example 1; and

FIG. 10 illustrates a graph of Y spacing of the nozzles of the inkjet printhead prepared according to Example 1.

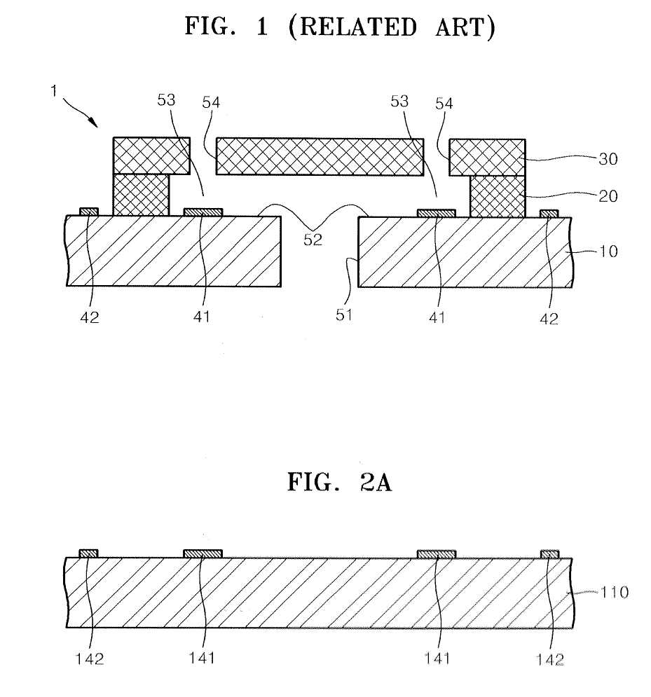

### DETAILED DESCRIPTION OF THE PREFERRED EMBODIMENTS

The present general inventive concept will now be described more fully with reference to the accompanying drawings, in which exemplary embodiments of the present general inventive concept are illustrated. However, the exemplary embodiments of the present general inventive concept are provided to describe the present general inventive concept to those of ordinary skill in the art, and the scope of the present general inventive concept is not limited to these exemplary embodiments. In the drawings, like reference numerals denote like elements, and the sizes or thickness of elements can be exaggerated for clarity. Also, if a first layer is formed on a second layer, the first layer may be directly on the second layer or a third layer may be interposed between the first and second layers. In addition, it will be understood that when a layer is referred to as being “formed on” another layer or substrate, it may be also “disposed on” the other layer or substrate.

Hereinafter, a method of manufacturing a thermal inkjet printhead will be described, however in alternative exemplary embodiments, the method may also be applied to a piezolelectric inkjet printhead. The method may further be applied to not only a monolithic structure but also a joint structure. In addition, the drawings illustrate portions of a silicon wafer, however, in exemplary embodiments, the single silicon wafer may include several tens to several hundreds of inkjet printheads as chips. Although not illustrated, the thermal inkjet printhead according to the present general inventive concept may also be incorporated within an image forming apparatus. In exemplary embodiments, the image forming apparatus may include the thermal inkjet printhead and an image forming unit (not illustrated) which forms an image by using the thermal inkjet printhead.

According to an exemplary embodiment of the present general inventive concept, there is provided a method of manufacturing an inkjet printhead, the method includes forming a heater for heating ink and an electrode for supplying current to the heater on a substrate, forming a flow path forming layer, which defines a flow path of ink, on the substrate on which the heater and the electrode are formed by coating a first negative photoresist composition on the substrate and patterning the first negative photoresist composition using a photolithography process, forming a sacrifice layer on the substrate on which the flow path forming layer is formed so as to cover the flow path forming layer, planarizing the top surface of the flow path forming layer and the sacrifice layer using a polishing process, forming a nozzle layer having nozzles by coating a second negative photoresist composition on the flow path forming layer and the sacrifice layer and pattering the second negative photoresist composition using a photolithography process, forming an ink feed hole in the substrate; and eliminating the sacrifice layer, wherein the first and second negative photoresist compositions each comprise a prepolymer which includes one of a glycidyl ether functional group, a ring-opened glycidyl ether functional group, and an oxytein functional group in a monomer repeat unit, and one of a phenol novolac resin-based backbone, a bisphenol-A-based backbone, a bisphenol-F-based backbone, and an alicyclic backbone; a cationic initiator, a solvent, and a plasticizer.

In exemplary embodiments, the first and second negative photoresist composition may be substantially the same or different than each other. In an further exemplary embodiments, the first and second negative photoresist compositions are substantially similar to each other.

The prepolymer in the first and second negative photoresist compositions may be exposed to an actinic radiation to form a crosslinked polymer.

The prepolymer may include a backbone monomer selected from the group consisting of phenol, o-cresol, p-cresol, bisphenol-A, an alicyclic compound, and a mixture thereof.

The prepolymer including the glycidyl ether functional group may be a bifunctional glycidyl ether functional group-and-a multi-functional glycidyl ether functional group as will -be described in more detail below. However, the present general inventive concept is not limited thereto.

First, the prepolymer including the bifunctional glycidyl ether functional group may be represented by Formula 1 below.

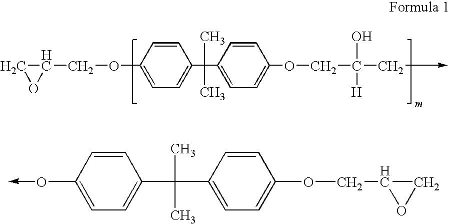

In Formula 1, m is an integer from 1 to 20.

The prepolymer including the bifunctional glycidyl ether functional group may form a film having a relatively low crosslinking density.

The prepolymer including the bifunctional glycidyl ether functional group may be EPON 828, EPON 1004, EPON 1001 F, or EPON 1010 purchased from Shell Chemical Company, DER-332, DER-331, or DER-164 purchased from Dow Chemical Company, and ERL-4201 or ERL-4289 purchased from Union Carbide Corporation. However, the present general inventive concept is not limited thereto.

In addition, the prepolymer including the multi-functional glycidyl ether functional group may be EPON SU-8 or EPON DPS-16 purchased from Shell Chemical Company, DEN-431 or DEN-439 purchased from Dow Chemical Company, and EHPE-3150 purchased from Daicel Chemical Industries, Ltd. However, the present general inventive concept is not limited thereto.

The prepolymer including a glycidyl ether functional group in a monomer repeat unit and a phenol novolac resin-based backbone may be represented by Formula 2 below.

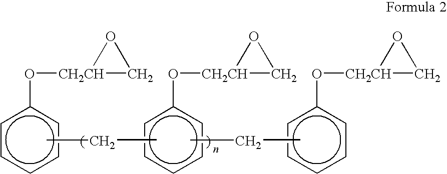

In Formula 2, n is about 1 to about 20, and, in an exemplary embodiment, n is about 1 to about 10.

In addition, the prepolymer including the glycidyl ether functional group in a monomer repeat unit and the phenol novolac resin-based backbone may include o-cresol or ρ-cresol instead of phenol, as illustrated in Formulae 3 and 4.

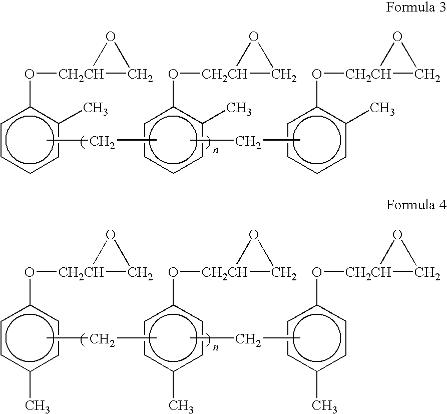

In Formulae 3 and 4, n is about 1 to about 20, and, in an exemplary embodiment, n is about 1 to about 10.

The prepolymer including a glycidyl ether functional group in a monomer repeat unit and a bisphenol-A-based backbone may include compounds represented by Formulae 5 and 6 below.

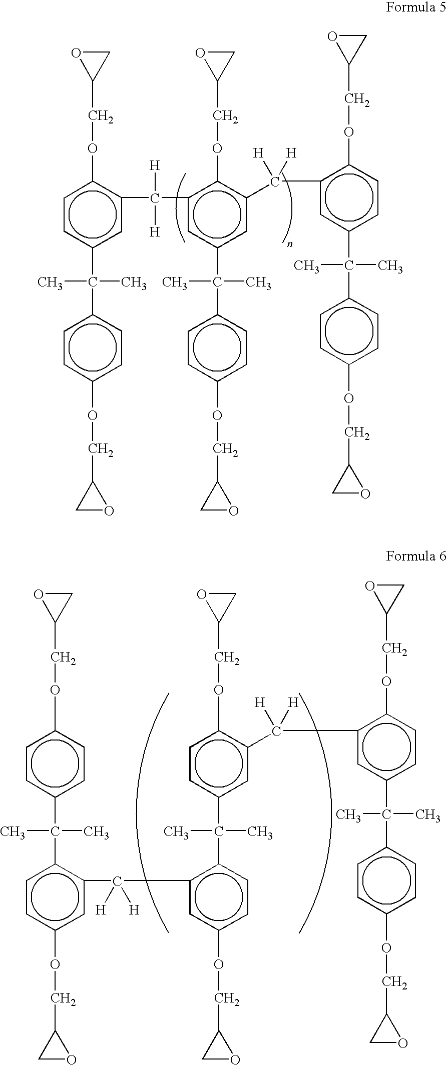

In Formulae 5 and 6, n is about 1 to about 20, and, in an exemplary embodiment, n is about 1 to about 10.

The prepolymer including a glycidyl ether functional group in a monomer repeat unit and an alicyclic backbone may be represented by Formula 7 below, and may include additional products of 1,2-epoxy-4(2-oxiranyl)-cyclohexane of 2,2-bis(hydroxy methyl)-1-butano which can be purchased as EHPH-3150. However, the present general inventive concept is not limited thereto.

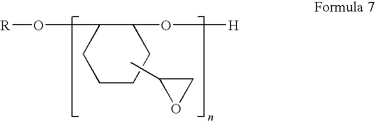

In Formula 7, n is about 1 to about 20, and, in an exemplary embodiment, n is about 1 to about 10.

The prepolymer including a glycidyl ether functional group in a monomer repeat unit and a bisphenol-F-based backbone may be represented by Formula 8 below.

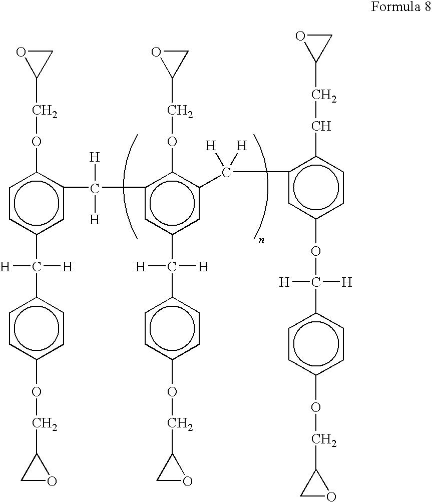

In Formula 8, n is about 1 to about 20, and, in an exemplary embodiment, n is about 1 to about 10.

The prepolymer including an oxytein functional group in a monomer repeat unit and a bisphenol-A-based backbone may be represented by Formula 9 below.

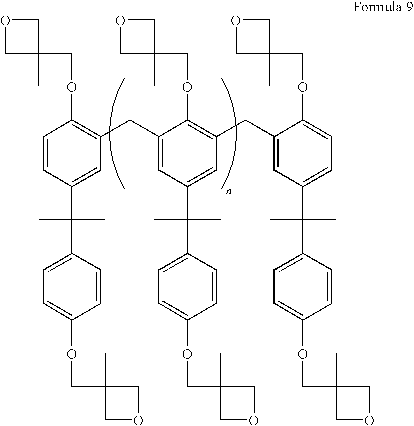

In Formula 9, n is about 1 to about 20, and, in an exemplary embodiment, n is about 1 to about 10.

The prepolymer may include at least one compound selected from the compounds represented by Formulae 1 to 9.

The cationic photoinitiator in the negative photoresist compositions may be an ion or a free radical that generally initiates polymerization when exposed to light. However, the present general inventive concept is not limited thereto. That is, the cationic photoinitiator may initiate polymerization when exposed to any other source of energy conventionally known in the art. The cationic photoinitiator may be an aromatic halonium salt and a sulfonium salt of elements of Groups VA and VI. In an exemplary embodiment, the cationic photoinitiator may be UVI-6974 purchased from Union Carbide Corporation or SP-17 purchased from Asahi Denka Co. Ltd. However, the present general inventive concept is not limited thereto.

The aromatic sulfonium salt may be triphenylsulfonium tetrafluoroborate, triphenylsulfonium hexafluoroantimonate (UVI-6974), phenylmethylbenzylsulfonium hexafluoroantimonate, phenylmethylbenzylsulfonium hexafluorophosphate, triphenylsulfonium-hexafluorophosphate, methyl diphenylsulfonium tetrafluoroborate, dimethyl phenylsulfonium hexafluorophosphate, or the like. However, the present general inventive concept is not limited thereto.

The aromatic halonium salt may be an aromatic iodonium salt, and the aromatic iodonium salt may be diphenyliodonium tetrafluoroborate, diphenyliodonium hexafluoroantimonate, or butylphenyliodonium hexafluoroantimonate (SP-172). However, the present general inventive concept is not limited thereto.

In exemplary embodiments, an amount of the cationic photoinitiator may be in the range of about 1 to about 10 parts by weight, based on 100 parts by weight of the prepolymer. In an exemplary embodiment, the amount of the cationic photoinitiator may be in the range of about 1.5 to about 5 parts by weight, based on 100 parts by weight of the prepolymer. If the amount of the cationic photoinitiator is less than about 1 part by weight, the crosslinking reaction cannot be sufficiently performed. On the other hand, if the amount of the cationic photoinitiator is greater than about 10 parts by weight, a crosslinking rate may be decreased, since a greater amount of photo energy is required.

In exemplary embodiments, the solvent in the negative photoresist compositions may be at least one selected from the group consisting of y-butyrolactone, propylene glycol methyl ethyl acetate, tetrahydrofuran, methyl ethyl ketone, methyl isobutyl ketone, cyclopentanone and xylene. However, the present general inventive concept is not limited thereto.

The amount of the solvent may be in the range of about 30 to about 300 parts by weight, based on 100 parts by weight of the prepolymer. In an exemplary embodiment, the amount of the solvent may be in the range of about 50 to about 200 parts by weight, based on 100 parts by weight of the prepolymer. If the amount of the solvent is less than about 30 parts by weight, viscosity is increased, thereby decreasing an operational efficiency. On the other hand, if the amount of the solvent is greater than about 300 parts by weight, viscosity of a produced polymer is substantially decreased so that a pattern may not be formed.

In exemplary embodiments, the plasticizer in the negative photoresist compositions may prevent or substantially reduce cracks from being generated in the nozzle layer after nozzles are developed in the nozzle layer and the sacrifice layer is eliminated in the forming of the nozzles. In addition, the plasticizer may also decrease defects of images due to Y spacing by decreasing variations of nozzle chamber angles, since the plasticizer having a high melting point functions as a lubricant among the crosslinked polymers to decrease stress in the nozzle layer. Furthermore, in exemplary embodiments, the plasticizer may simplify an entire process, since a baking process may be eliminated.

In exemplary embodiments, the plasticizer may be a phthalate-based compound, a trimellitate-based compound, or a phosphate-based compound. The phthalate-based plasticizer may be dioctyl phthalate (DOP) and diglycidyl hexahydro phthalate (DGHP). However, the present general inventive concept is not limited thereto. The trimellitate-based plasticizer may be triethylhexyl trimellitate, and the phosphate-based plasticizer may be tricresyl phosphate. In exemplary embodiments, the plasticizer may be used alone or in a combination of at least two of the above listed compounds. However, the present general inventive concept is not limited thereto.

In exemplary embodiments, the amount of the plasticizer may be in the range of about 1 to about 15 parts by weight, based on 100 parts by weight of the prepolymer. In an exemplary embodiment, the amount of the plasticizer may be in the range of about 5 to about 10 parts, based on 100 parts by weight of the prepolymer. If the amount of the plasticizer is less than about 1 part by weight, the effect of the plasticizer is negligible. On the other hand, if the amount of the plasticizer is greater than about 15 parts by weight, crosslinking density of the prepolymer may be decreased.

In exemplary embodiments, the negative photoresist compositions may further include a photosensitizer, a filling agent, a viscosity modifier, a moisturizer, a photostabilizer, or the like, as additives, and the amount of the additives may be in the range of about 0.1 to about 20 parts by weight, based on 100 parts by weight of the prepolymer. However, the present general inventive concept is not limited thereto.

The photosensitizer absorbs light energy and passes its energy to another substance to form a radical or ionic initiator. In an exemplary embodiment, the photosensitizer enlarges an energy wavelength range efficient to light exposure and is typically an aromatic light-absorbing chromophore. In addition, the photosensitizer may induce formation of the radical or ionic photoinitiator.

A method of manufacturing an inkjet printhead according to the present general inventive concept includes forming a heater for heating ink and an electrode for supplying current to the heater on a substrate, forming a flow path forming layer, which defines a flow path of ink, on the substrate on which the heater and the electrode are formed by coating a first negative photoresist composition on the substrate and patterning the first negative photoresist composition using a photolithography process, forming a sacrifice layer on the substrate on which the flow path forming layer is formed so as to cover the flow path forming layer, planarizing the top surface of the flow path forming layer and the sacrifice layer using a polishing process, forming a nozzle layer having nozzles by coating a second negative photoresist composition on the flow path forming layer and the sacrifice layer and pattering the second negative photoresist composition using a photolithography process, forming an ink feed hole in the substrate, and eliminating the sacrifice layer, wherein the first and second negative photoresist compositions may each include: a prepolymer which includes one of a glycidyl ether functional group, a ring-opened glycidyl ether functional group, and an oxytein functional group in a monomer repeat unit, and one of a phenol novolac resin-based backbone, a bisphenol-A-based backbone, a bisphenol-F-based backbone, and an alicyclic backbone; a cationic initiator; a solvent; and a plasticizer.

In an exemplary embodiment of the method, the substrate may be a silicon wafer. However, the present general inventive concept is not limited thereto.

In the present exemplary embodiment of the method, a forming of the flow path forming layer may include forming a first photoresist layer by coating the first negative photoresist composition on an entire surface of the substrate, exposing the first photoresist layer to light by using a first photomask including an ink flow path pattern, and eliminating portions which are not exposed to light by developing the first photoresist layer.

In the present exemplary embodiment of the method, a sacrifice layer may include a positive photoresist polymer or a non-sensitized soluble polymer. The positive photoresist polymer may be an imide-based positive photoresist polymer, and the non-sensitized soluble polymer may be at least one of a phenol resin, a polyurethane resin, an epoxy resin, a poly imide resin, an acryl resin, a poly amide resin, an urea resin, a melamine resin and a silicon resin. In this regard, “soluble” indicates properties of being soluble in a specific solvent.

In the forming of the sacrifice layer, a thickness of the sacrifice layer may be greater than that of the flow path forming layer. In this regard, the sacrifice layer may be formed using a spin coating process. However, the present general inventive concept is not limited thereto. That is, in exemplary embodiments, the sacrifice layer may be formed by various other coating processes conventionally known in the art.

In the planarizing operation, the top surface of the flow path forming layer and the sacrifice layer is polished to a predetermined height, such as a height of the ink-flow path. In exemplary embodiments, the polishing process may include chemical mechanical planarization (CMP).

In the present exemplary embodiment of the method, the forming of the nozzle layer may include forming a second photoresist layer by coating a second negative photoresist composition on the flow path forming layer and the sacrifice layer, exposing the second photoresist layer to light by using a second photomask having a nozzle pattern, and forming the nozzle layer having nozzles by eliminating portions which are not exposed to light by developing the second photoresist layer.

In exemplary embodiments, the forming of the ink feed hole may include coating a photoresist composition on a surface of the substrate, such as a bottom surface of the substrate, forming an etching mask in order to form the ink feed hole by patterning the photoresist composition, and forming the ink feed hole by etching the bottom surface of the substrate exposed through the etching mask. In this regard, the bottom surface of the substrate, for example, may be etched using a dry etching method using plasma or a wet etching method using tetra-methyl ammonium hydroxide (TMAH) or KOH as an etching solution. However, the present general inventive concept is not limited thereto.

According to the present general inventive concept, uniformity of the ink flow path may be increased since a shape and size of the ink flow path may be more easily controlled by planarizing the top surface of the sacrifice layer.

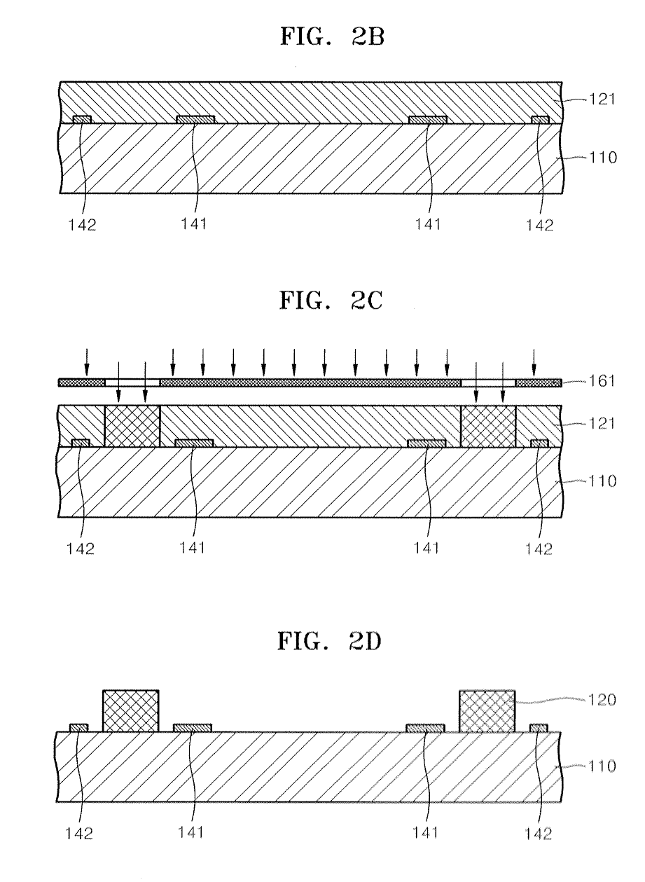

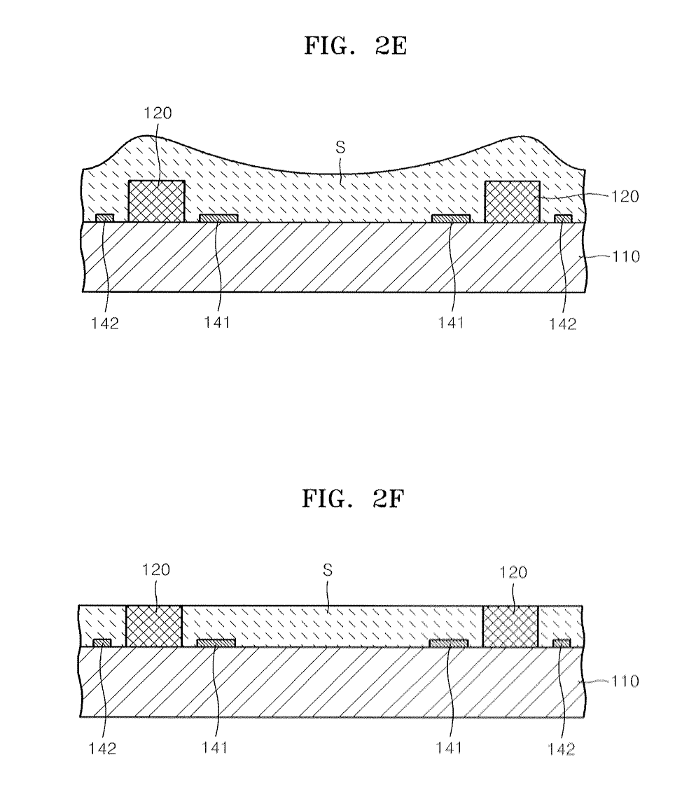

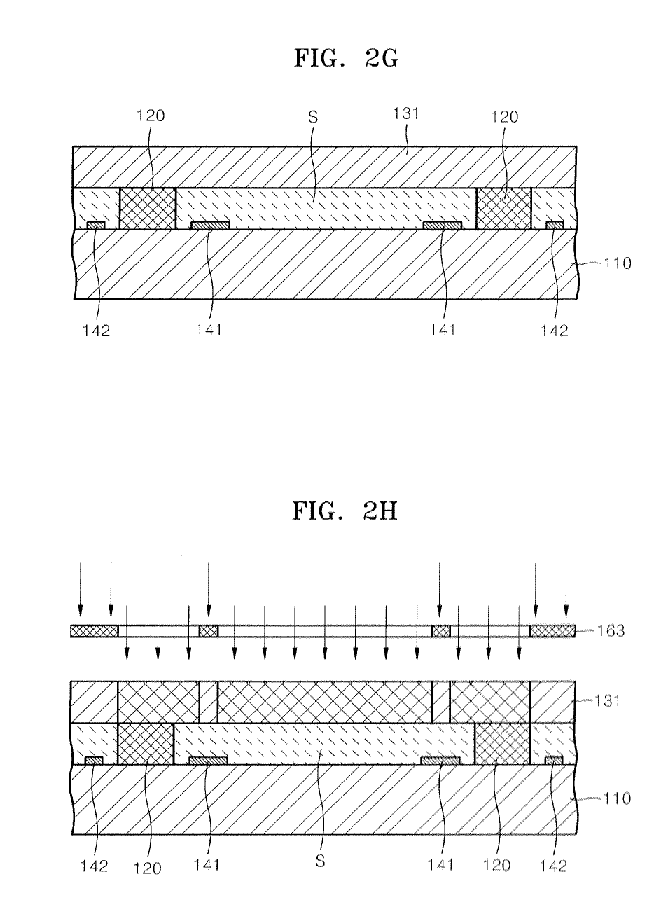

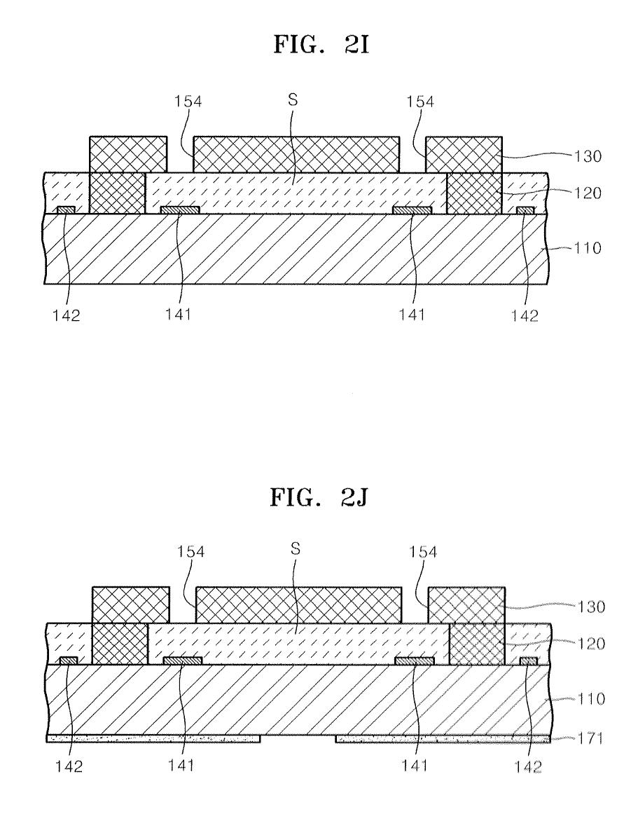

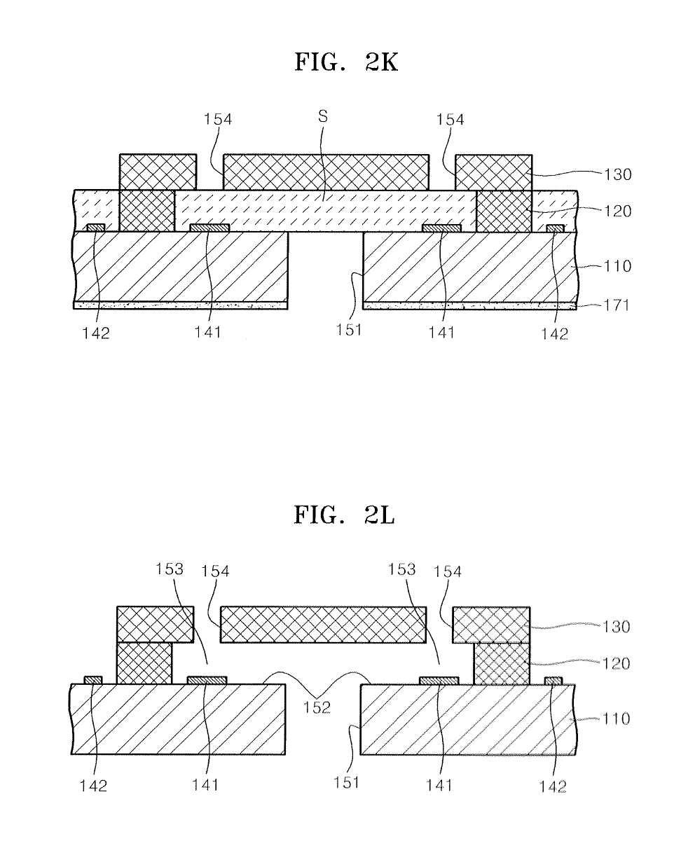

FIGS. 2A to 2L illustrate cross-sectional views which describe a method of manufacturing an inkjet printhead according to an exemplary embodiment of the present general inventive concept, in which a flow path forming layer and a nozzle layer are formed using a negative photoresist composition including the prepolymer, and a sacrifice layer is planarized using CMP.

First, as illustrated in FIG. 2A, a heater 141 to heat ink and an electrode 142 to supply current to the heater are formed or disposed on a substrate 110. The substrate 110 may be a silicon wafer. The silicon wafer is widely used in semiconductor devices and is efficient for mass production of semiconductor devices.

In exemplary embodiments, the heater 141 may be formed by depositing a resistance heating material, such as a tantalum-nitride or a tantalum-aluminum alloy, on the substrate 110 by using sputtering or chemical vapor deposition process, and patterning the resistance heating material.

In exemplary embodiments, the electrode 142 may be formed by depositing a metal having an excellent conductivity, such as aluminum or an aluminum alloy, on the substrate 110 by using a sputtering process, and patterning the metal. Meanwhile, a protective layer formed of a silicon oxide or a silicon nitride may be formed on the heater 141 and on the electrode 142 (not illustrated).

Then, as illustrated in FIG. 2B, a first negative photoresist layer 121 is formed on the substrate 110 on which the heater 141 and the electrode 142 are formed. The first negative photoresist layer 121 forms the flow path forming layer 120 (FIG. 2D) which surrounds an ink chamber and a restrictor. The first negative photoresist layer 121 is stable in the presence of ink since the first negative photoresist layer 121 is crosslinked by actinic radiations such as ultraviolet (UV) rays. In exemplary embodiments, the first negative photoresist layer 121 may be formed using a photoresist composition including the prepolymer. In particular, the first negative photoresist layer 121 may be formed by coating the negative photoresist composition on the substrate 110 to a predetermined thickness. In this regard, the negative photoresist composition may be coated on the substrate 110 using a spin coating process. However, the present general inventive concept is not limited thereto. That is, the negative photoresist composition may be coated on the substrate 110 by using various other processes conventionally known in the art.

Then, as illustrated in FIG. 2C, the first negative photoresist layer 121 is exposed to actinic radiation, preferably UV rays, using a first photomask 161 having patterns of the ink chamber and the restrictor thereon. In the exposure operation, portions of the first negative photoresist layer 121, which are exposed to UV rays, are hardened to thereby have excellent chemical durability and a high mechanical strength. On the other hand, a developer may easily dissolve portions of the first negative photoresist layer 121 which are not exposed to UV rays.

Then, the portions which are not exposed to UV rays are eliminated by developing the first negative photoresist layer 121 in order to form a flow path forming layer 120, which defines ink flow paths as illustrated in FIG. 2D.

Then, as illustrated in FIG. 2E, a sacrifice layer S is formed on the substrate 110 to cover the flow path forming layer 120. Thus, in an exemplary embodiment, a thickness of the sacrifice layer S may be greater than that of the flow path forming layer 120. In exemplary embodiments, the sacrifice layer S may be formed by coating a positive photoresist polymer or a non-sensitized soluble polymer on the substrate 110 to a predetermined thickness by using a spin coating process. In this regard, the positive photoresist polymer may be an imide-based positive photoresist polymer. In exemplary embodiments, the imide-based positive photoresist polymer used as the sacrifice layer S may not by affected by a solvent and may not generate nitrogen gas when exposed to light. For this, the imide-based positive photoresist polymer should be treated using a hard baking process at about 140° C. Meanwhile, in alternative exemplary embodiments, the sacrifice layer S may be formed by spin coating a liquid phase non-sensitized soluble polymer on the substrate 110 to a predetermined thickness, and then baking the resultant. In this regard, the liquid phase non-sensitized soluble polymer may be at least one selected from the group consisting of a phenol resin, a polyurethane resin, an epoxy resin, a poly imide resin, an acryl resin, a poly amide resin, an urea resin, a melamine resin, a silicon resin, and a combination thereof.

Then, in exemplary embodiments, a top surface of the flow path forming layer 120 and the sacrifice layer S may be planarized in order to be flush with each other using CMP, as illustrated in FIG. 2F. More specifically, if the top surface of the sacrifice layer S and the flow path forming layer 120 are polished to a height of the ink flow path using CMP, the flow path forming layer 120 and the sacrifice layer S may have substantially the same thickness.

Then, a second negative photoresist layer 131 is formed or disposed on the planarized flow path forming layer 120 and the sacrifice layer S, as illustrated in FIG. 2G. In exemplary embodiments, the second negative photoresist layer 131 may be formed using a prepolymer which includes one of a glycidyl ether functional group, a ring-opened glycidyl ether functional group, and an oxytein functional group in a monomer repeat unit, and one of a phenol novolac resin-based backbone, a bisphenol-A-based backbone, a bisphenol-F-based backbone, and an alicyclic backbone, similar to the formation of the first negative photoresist layer 121.

In exemplary embodiments, the second negative photoresist layer 131 is formed into a nozzle layer 130 (FIG. 2J). The second negative photoresist layer 131 is stable in the presence of ink since the second negative photoresist layer 131 is crosslinked by actinic radiations, such as UV rays. Specifically, the second negative photoresist layer 131 is formed by coating the prepolymer composition on the flow path forming layer 120 and on the sacrifice layer S to a predetermined thickness using a spin coating process. In the present exemplary embodiment, a thickness of the second negative photoresist layer 131 is sufficient enough to secure desired lengths of nozzles and also to sustain pressure changes in the ink chamber.

Since the sacrifice layer S and the flow path forming layer 120 are planarized and thus have the same thickness, edges of the sacrifice layer S are not distorted or melted due to reactions between the materials which are used to form the second negative photoresist layer 131 and the materials which are used to form the sacrifice layer S. Thus, in exemplary embodiments, the second negative photoresist layer 131 may be adhered to the top surface of the flow path forming layer 120.

Then, as illustrated in FIG. 2H, the second negative photoresist layer 131 is exposed to light by using a second photomask 163 having a nozzle pattern thereon. If portions of the second negative photoresist layer 131, which are not exposed to light, are eliminated by developing the second negative photoresist layer 131, nozzles 154 are formed and portions of the second negative photoresist layer 131, which are hardened by the light exposure, remain to thereby form the nozzle layer 130, as illustrated in FIG. 21. In exemplary embodiments, if the sacrifice layer S is formed of the imide-based positive photoresist polymer, as described above, nitrogen gas is not generated when the sacrifice layer S is exposed to light through the second negative photoresist layer 131, and thus the nozzle layer 130 may not be distorted.

Then, as illustrated in FIG. 2J, an etching mask 171 is formed or disposed on the bottom surface of the substrate 110 in order to form an ink feed hole 151 (FIG. 2K). In exemplary embodiments, the etching mask 171 may be formed by coating a positive or negative photoresist on the bottom surface of the substrate 110, and then patterning the resultant.

Then, as illustrated in FIG. 2K, an ink feed hole 151 is formed by etching through to penetrate the substrate 110 from the bottom surface of the substrate 110 which is exposed by the etching mask 171, and then eliminating the etching mask 171. In exemplary embodiments, the bottom surface of the substrate 110 may be etched using a dry etching method, for example, by using plasma. Meanwhile, in alternative exemplary embodiments, the bottom surface of the substrate 110 may be etched using a wet etching method, for example, by using tetra-methyl ammonium hydroxide (TMAH) or KOH as an etching solution.

Finally, when the sacrifice layer S is eliminated by using a solvent, an ink chamber 153, and a restrictor 152, which are surrounded by the flow path forming layer 120 are formed, and the electrode 142 which supplies current to the heater 141 is exposed, as illustrated in FIG. 2L. Accordingly, the inkjet printhead having a structure as illustrated in FIG. 2L is completed.

The present general inventive concept will now be described in further detail with reference to the following examples. However, these examples are for illustrative purposes only and are not intended to limit the scope of the present general inventive concept.

### PREPARATION EXAMPLE 1

### Preparation of Negative Photoresist Composition

30 gram (g) of Propylene Glycol Methyl Ether Acetate (PGMEA) (Samchun Chemical Co.), 2 g of diglycidyl hexahydro phthalate (Sigma-Aldrich Co.), and 2 g of SP-172 (Asahi Denka Korea Chemical Co.) were added to a jar in order to prepare a resist solution. Then, 40 g of EPON SU-8 (Hexion Speciality Co.) was then added thereto. The mixture was mixed in an impeller for 24 hours before being used to prepare a negative photoresist composition.

### PREPARATION EXAMPLE 2

A negative photoresist composition was prepared in the same manner as described in Preparation Example 1, except that the diglycidyl hexahydro phthalate was not used.

### EXAMPLE 1

A tantalum nitride heater pattern 141 having a thickness of about 500 Å and an electrode pattern 142 which was formed of an aluminum silicon copper (AlSiCu) alloy (the amounts of Si and Cu are respectively less than 1 wt %) having a thickness of about 500 Å were formed on a 6-inch silicon wafer 110 by using a sputtering process and photolithography (FIG. 2A).

Then, as illustrated in FIG. 2B, a negative photoresist composition prepared according to Preparation Example 1 was spin coated on a front surface of the silicon wafer, on which the heater pattern and the electrode pattern are formed, at a rate of 2000 rpm for 40 seconds, and the resultant was then baked at 95° C. for 7 minutes in order to form a first negative photoresist layer having a thickness of about 10 μm. Then, as illustrated in FIG. 2C, the first negative photoresist layer was exposed to i-line UV rays by using a first photomask having a predetermined ink chamber pattern and restrictor pattern formed thereon. In this regard, the amount of light was controlled to 130 mJ/cm². The wafer was baked at 95° C. for 3 minutes, immersed in a PGMEA developer for 1 minute, and then rinsed with isopropanol for 20 seconds. Thus, a flow path forming layer 120 (FIG. 2D) was thereby prepared.

Then, as illustrated in FIG. 2E, an imide-based positive photoresist polymer (Model No.: PW-1270, manufactured by Toray Industries, Inc.) was spin coated on an entire surface of the wafer, on which the flow path forming layer pattern 120 is formed, at a rate of 1000 rpm for 40 seconds, and the resultant was then baked at about 140° C. for 10 minutes in order to form a sacrifice layer S. A thickness of the sacrifice layer S was controlled such that the thickness of over-coating on the flow path forming layer 120 was about 5 μm.

Then, the top surface of the flow path forming layer pattern 120 and the sacrifice layer S was planarized using CMP, as illustrated in FIG. 2F. For the planarization, the wafer was placed onto a polishing pad such that the sacrifice layer S faced the polishing pad of a polishing plate (Model no.: JSR FP 8000, manufactured by JSR Co., Ltd.). Then, the wafer was pressed onto the polishing pad, under a pressure of 10-15 kPa with a backing pad, by a press head. The press head was rotated with respect to the polishing plate, while polishing slurries (FUJIMI Corporation, POLIPLA 103) were supplied onto the polishing pad. At this time, the rotation speed of each of the press head and the polishing pad was 40 rpm. Here, the rotating rates of the press head and the polishing pad were respectively 40 rpm. The backing pad was formed of a material having a shore D hardness in the range of about 30 to about 70. The sacrifice layer S was removed to be planarized until about 1 μm of the top surface of the flow path forming layer pattern 120 is eliminated while the etching rate was controlled to about 5 to about 7 μm.

A nozzle layer pattern 130 was formed using a negative photoresist composition and a photomask 163 prepared according to Preparation Example 1 on the silicon wafer 110, on which the flow path forming layer pattern 120 and the sacrifice layer S are formed, under the same conditions for the formation of the flow path forming layer pattern 120 (FIGS. 2G, 2H, and 2I).

As illustrated in FIG. 2J, an etching mask 171 was formed using a typical photolithography process in order to form an ink feed hole 151 in the bottom surface of the silicon wafer 110. Then, as illustrated in FIG. 2K, after the ink feed hole 151 was formed by etching the silicon wafer 110 by using plasma from the bottom surface of the silicon wafer 110 which was exposed through the etching mask 171, the etching mask 171 was eliminated. In this regard, in the plasma etching device, the power was 2000 Watt, the etching gas was a mixture of sulfur hexafluoride (SF₆) and oxygen (O₂) (volume ratio=10:1), and the etching rate was 3.7 μm/min.

Finally, the silicon wafer was dipped in a methyl lactate solvent for 2 hours to remove the sacrifice layer S, and thus an ink chamber 153 and a restrictor 152, which were surrounded by the flow path forming layer 120, were formed in portions in which the sacrifice layer S was eliminated, as illustrated in FIG. 2L. As a result, an inkjet printhead having the structure illustrated in FIG. 2L was thereby prepared.

As described above, an inkjet printhead was prepared using the negative photoresist composition prepared according to Preparation Example 1 as the first negative photoresist composition and as the second negative photoresist composition.

### COMPARATIVE EXAMPLE 1

An inkjet printhead was prepared in the same manner as in Example 1, except that the negative photoresist composition which was prepared according to Preparation Example 2 was used.

As described above, an inkjet printhead was prepared using the negative photoresist composition prepared according to Preparation Example 2 as the first negative photoresist composition and as the second negative photoresist composition.

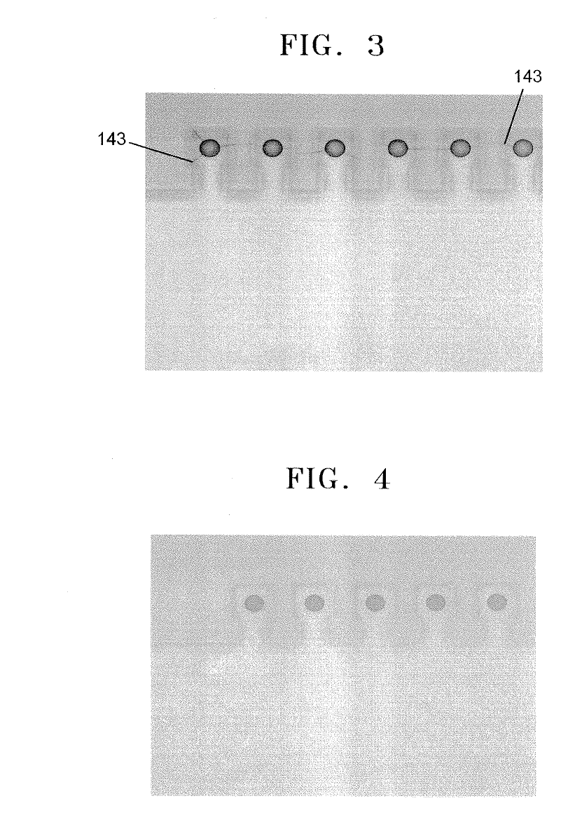

FIG. 3 is an optical microscope image of a nozzle layer prepared according to Comparative Example 1 after nozzles were developed in the nozzle layer. FIG. 4 is an optical microscope image of a nozzle layer prepared according to Example 1 after nozzles were developed in the nozzle layer. Referring to FIGS. 3 and 4, it is clear that the nozzle layer prepared according to Comparative Example 1, which did not use a plasticizer, includes numerous cracks 143, while the nozzle layer prepared according to Example 1, according to an exemplary embodiment of the present general inventive concept, which did use a plasticizer in the photoresist composition, did not have cracks 143 as a result of decreased stress on the -materials which were used to form the nozzles.

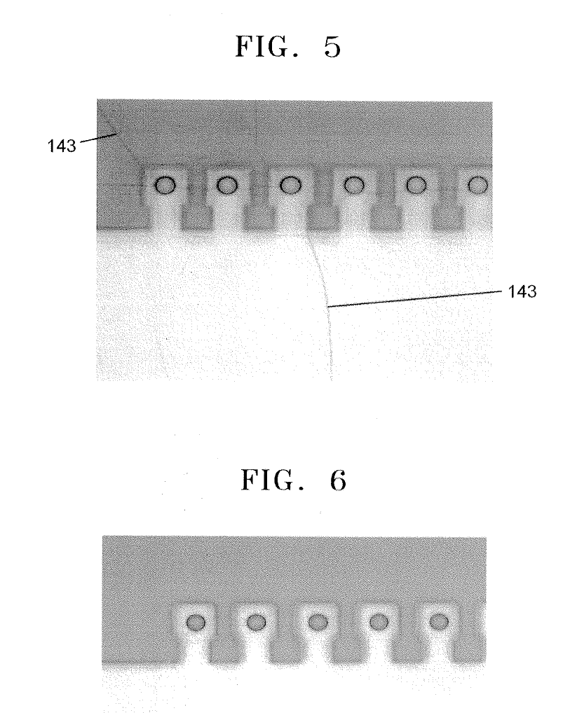

FIG. 5 is an optical microscope image of a nozzle layer prepared according to Comparative Example 1 after a sacrifice layer was eliminated, and FIG. 6 is an optical microscope image of a nozzle layer prepared according to Example 1 after a sacrifice layer was eliminated. Referring now to FIGS. 5 and 6, it is clear that the nozzle layer prepared according to Comparative Example 1, which did not use a plasticizer, includes numerous cracks 143, while the nozzle layer prepared according to Example 1, according to an exemplary embodiment of the present general inventive concept, which did use a plasticizer in a photoresist composition, did not have cracks 143 as a result of decreased stress on the materials which were used to form the nozzles.

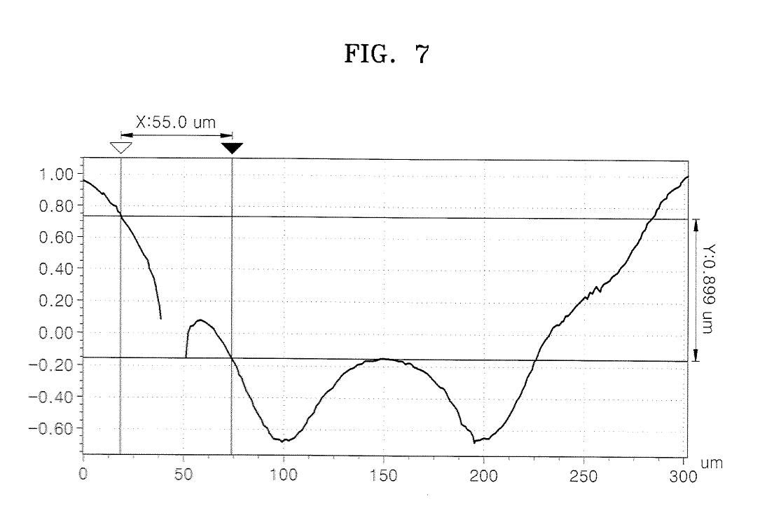

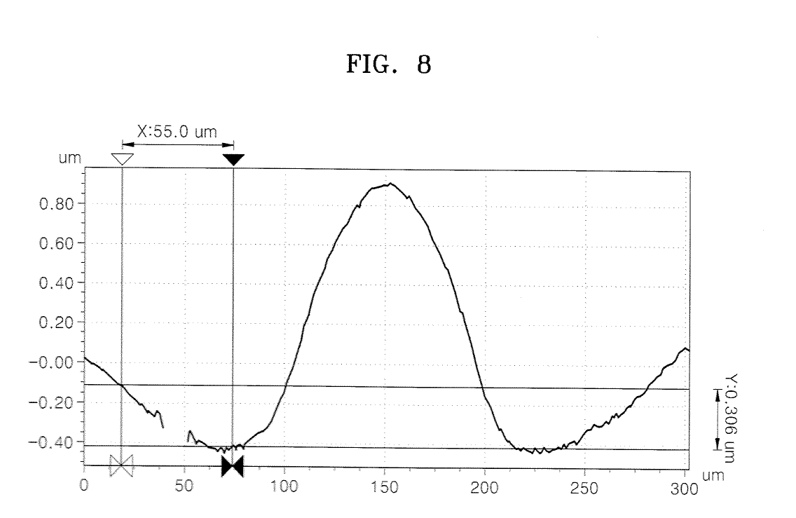

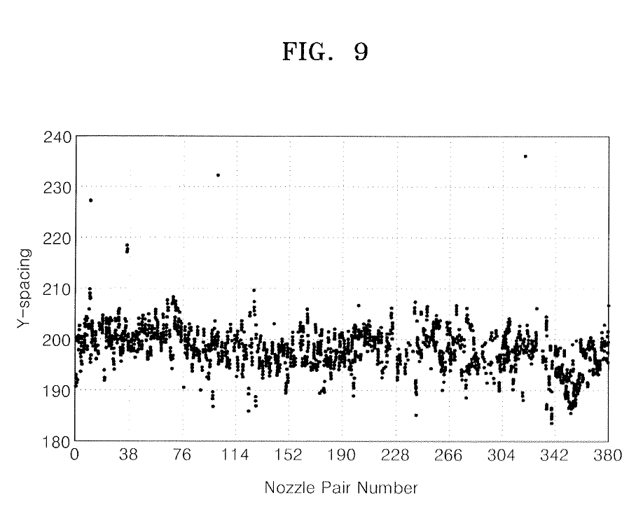

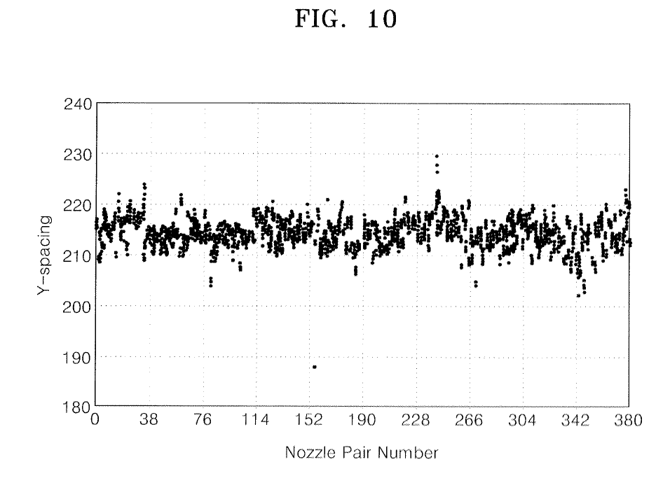

Also, FIGS. 7 and 9 respectively illustrate graphs of nozzle chamber angles and Y spacing of nozzles of an inkjet printhead prepared according to Comparative Example 1, and FIGS. 8 and 10 illustrate graphs of nozzle chamber angles and Y spacing of nozzles of an inkjet printhead prepared according to Example 1. Referring now to FIGS. 7 to 10, it is clear that an average nozzle chamber angle of the inkjet printhead prepared according to Comparative Example 1, which did not use a plasticizer, was 1.9 degree, while an average nozzle chamber angle of the inkjet printhead prepared according to Example 1, which did use a plasticizer, was 0.5 degree. Thus, images obtained by using the inkjet printhead according to the present general inventive concept were improved since dot alignment between the EVEN and ODD lines was substantially improved.

According to the present general inventive concept, image deterioration due to Y spacing may be prevented or substantially reduced by decreasing nozzle cracks and nozzle chamber angles, since a flexibility of a nozzle plate is increased by adding a plasticizer to a photoresist composition used to form nozzles.

While the present general inventive concept has been particularly illustrated and described with reference to a few exemplary embodiments thereof, it will be understood by one of ordinary skill in the art that various changes in form and details may be made therein without departing from the spirit and scope of the present general inventive concept as defined by the following claims.

What is claimed is:

1. A method of manufacturing an inkjet printhead, the method comprising:
forming a heater to heat ink and an electrode to supply current to the heater on a substrate;
forming a flow path forming layer, which defines a flow path of the ink, on the substrate on which the heater and the electrode are disposed, by coating a first negative photoresist composition on the substrate and patterning the first negative photoresist composition using a photolithography process;
forming a sacrifice layer on the substrate, on which the flow path forming layer is disposed, so as to cover the flow path forming layer;
planarizing a top surface of the flow path forming layer and the sacrifice layer using a polishing process;
forming a nozzle layer having nozzles by coating a second negative photoresist composition on the flow path forming layer and the sacrifice layer and patterning the second negative photoresist composition by using a photolithography process;
forming an ink feed hole in the substrate; and
eliminating the sacrifice layer,
wherein the first and second negative photoresist compositions comprise a prepolymer which comprises one selected from the group consisting of a glycidyl ether functional group, a ring-opened glycidyl ether functional group, and an oxytein functional group in a monomer repeat unit, and one selected from the group consisting of a phenol novolac resin-based backbone, a bisphenol-A-based backbone, a bisphenol-F-based backbone, and an alicyclic backbone; a cationic initiator; a solvent; and a plasticizer.

2. The method of claim 1, wherein the polishing process comprises chemical mechanical planarization.

3. The method of claim 1, wherein the first and second negative photoresist compositions are substantially similar.

4. The method of claim 1, wherein the forming of the flow path forming layer comprises:
forming a first photoresist layer by coating the first negative photoresist composition on a surface of the substrate;
exposing the first photoresist layer to a light by using a first photomask having an ink flow path pattern; and
eliminating portions which are not exposed to the light by developing the first photoresist layer.

5. The method of claim 1, wherein the sacrifice layer comprises a positive photoresist polymer or a non-sensitized soluble polymer.

6. The method of claim 1, wherein the positive photoresist polymer is an imide-based positive photoresist polymer.

7. The method of claim 5, wherein the non-sensitized soluble polymer is at least one selected from the group consisting of a phenol resin, a polyurethane resin, an epoxy resin, a poly imide resin, an acryl resin, a poly amide resin, an urea resin, a melamine resin, and a silicon resin.

8. The method of claim 1, wherein the forming of the sacrifice layer is performed by using a spin coating process.

9. The method of claim 1, wherein the forming of the nozzle layer comprises:
forming a second photoresist layer by coating a second negative photoresist composition on the flow path forming layer and the sacrifice layer;
exposing the second photoresist layer to a light by using a second photomask having a nozzle pattern; and
forming nozzles and a nozzle layer by eliminating portions which are not exposed to the light by developing the second photoresist layer.

10. The method of claim 1, wherein the forming of the ink feed hole comprises:
coating a photoresist composition on a bottom surface of the substrate;
forming an etching mask in order to form the ink feed hole by patterning the photoresist composition; and
forming the ink feed hole by etching the bottom surface of the substrate which is exposed through the etching mask.

11. The method of claim 10, wherein the bottom surface of the substrate is etched using a dry etching method using plasma.

12. The method of claim 10, wherein the bottom surface of the substrate is etched using a wet etching method using tetra-methyl ammonium hydroxide (TMAH) or KOH as an etching solution.

13. The method of claim 1, wherein the first and second negative photoresist compositions respectively comprise about 1 to about 10 parts by weight of the cationic initiator, about 30 to about 300 parts by weight of the solvent, and about 1 to about 15 parts by weight of the plasticizer, based on 100 parts by weight of the prepolymer.

14. The method of claim 1, wherein the prepolymer comprises a backbone monomer selected from the group consisting of phenol, o-cresol, p-cresol, bisphenol-A, an alicyclic compound, and a mixture thereof.

15. The method of claim 1, wherein the prepolymer comprises at least one compound selected from the group consisting of the compounds represented by Formulae 1 to 9 below: 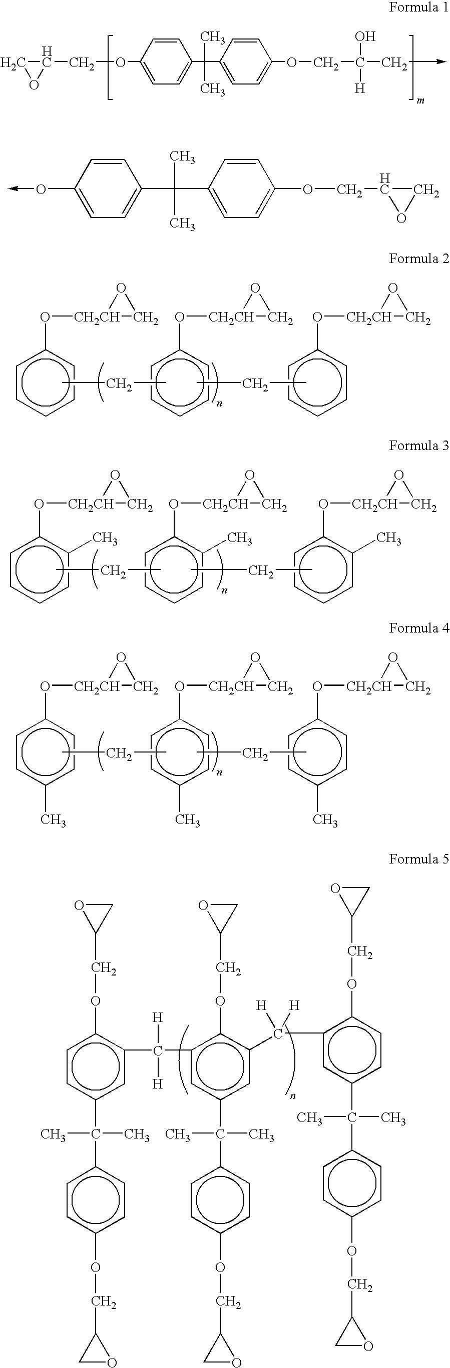 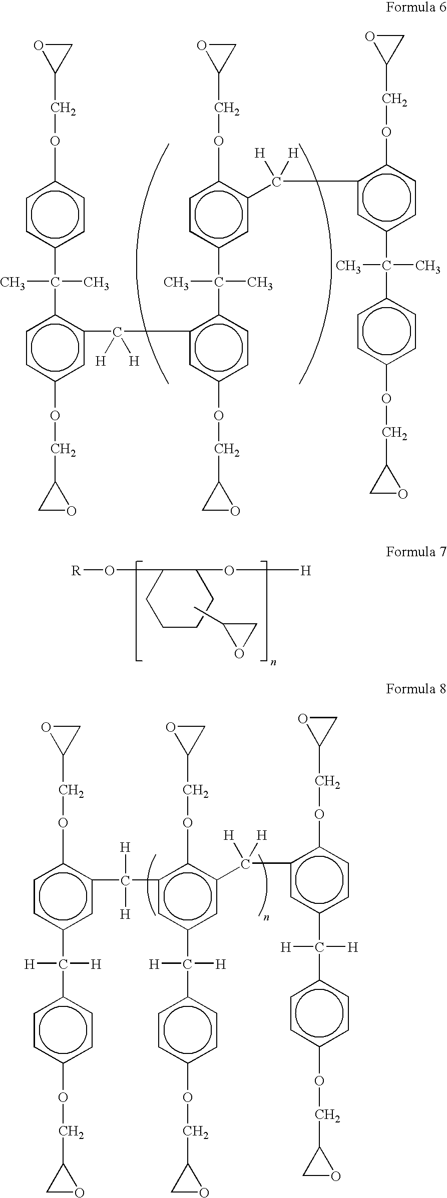 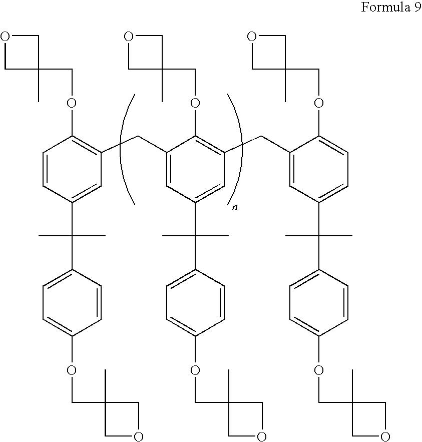
where m is an integer from 1 to 20, and n is an integer from 1 to 20.

16. The method of claim 1, wherein the cationic initiator is a sulfonium salt or an iodonium salt.

17. The method of claim 1, wherein the solvent is at least one selected from the group consisting of γ-butyrolactone, propylene glycol methyl ethyl acetate (PGMEA), tetrahydrofuran (THF), methyl ethyl ketone, methyl isobutyl ketone, cyclopentanone, and a mixture thereof.

18. The method of claim 1, wherein the plasticizer is at least one selected from the group consisting of a phthalate-based compound, a trimellitate-based compound, and a phosphite-based compound.

19. The method of claim 1, wherein the plasticizer is at least one selected from the group consisting of dioctyl phthalate, diglycidyl hexahydro phthalate, triethylhexyl trimellitate, and tricresyl phosphite.

20. A method of manufacturing an inkjet printhead, the method comprising:
forming a flow path layer on a substrate by disposing a first negative photoresist composition on the substrate; and
forming a nozzle layer by disposing a second negative photoresist composition on the flow path layer,
wherein the first and second negative photoresist compositions comprise a prepolymer, a cationic initiator, a solvent, and a plasticizer.

21. An inkjet printhead manufactured by forming a heater to heat ink and an electrode to supply current to the heater disposed on a substrate, forming a flow path forming layer which defines a flow path of ink on the substrate, on which the heater and the electrode are disposed, by coating a first negative photoresist composition on the substrate and patterning the first negative photoresist composition using a photolithography process, forming a sacrifice layer on the substrate, on which the flow path forming layer is disposed, so as to cover the flow path forming layer, planarizing a top surface of the flow path forming layer and the sacrifice layer using a polishing process, forming a nozzle layer having nozzles by coating a second negative photoresist composition on the flow path forming layer and the sacrifice layer and patterning the second negative photoresist composition using a photolithography process, forming an ink feed hole in the substrate, and eliminating the sacrifice layer, wherein the first and second negative photoresist compositions comprise a prepolymer which comprises one selected from the group consisting of a glycidyl ether functional group, a ring-opened glycidyl ether functional group, and an oxytein functional group in a monomer repeat unit, and one selected from the group consisting of a phenol novolac resin-based backbone, a bisphenol-A-based backbone, a bisphenol-F-based backbone, and an alicyclic backbone; a cationic initiator; a solvent; and a plasticizer.

22. An image forming apparatus comprising:
an inkjet printhead manufactured by forming a heater to heat ink and an electrode to supply current to the heater disposed on a substrate, forming a flow path forming layer which defines a flow path of ink on the substrate, on which the heater and the electrode are disposed, by coating a first negative photoresist composition on the substrate and patterning the first negative photoresist composition using a photolithography process, forming a sacrifice layer on the substrate, on which the flow path forming layer is disposed, so as to cover the flow path forming layer, planarizing a top surface of the flow path forming layer and the sacrifice layer using a polishing process, forming a nozzle layer having nozzles by coating a second negative photoresist composition on the flow path forming layer and the sacrifice layer and patterning the second negative photoresist composition using a photolithography process, forming an ink feed hole in the substrate, and eliminating the sacrifice layer, wherein the first and second negative photoresist compositions comprise a prepolymer which comprises one selected from the group consisting of a glycidyl ether functional group, a ring-opened glycidyl ether functional group, and an oxytein functional group in a monomer repeat unit, and one selected from the group consisting of a phenol novolac resin-based backbone, a bisphenol-A-based backbone, a bisphenol-F-based backbone, and an alicyclic backbone; a cationic initiator; a solvent; and a plasticizer; and
an image forming unit to form an image by using the inkjet printhead.
